(19) United States
(12) Patent Application Publication
(10) Pub. No.: US 2006/0053030 A1
(43) Pub. Date: Mar. 9, 2006

(54) Method of recycling a liquid cartridge

(76) Inventors: Hiroto Nakamura, Nagano (JP); Akio Owatari, Nagano (JP); Tomio Yokoyama, Nagano (JP); Hikaru Mukaiyama, Nagano (JP); Morio Sato, Nagano (JP)

Correspondence Address: STROOCK & STROOCK & LAVAN LLP, 180 MAIDEN LANE, NEW YORK, NY, 10038, US

(21) Appl. No.: 11/217,987

(22) Filed: Sep. 1, 2005

(30) Foreign Application Priority Data
Sep. 7, 2004 (JP) P2004-259329
Sep. 15, 2004 (JP) P2004-267881
Sep. 15, 2004 (JP) P2004-267882

(51) Int. Cl. G06Q 99/00

(52) U.S. Cl. 705/1

(57) ABSTRACT

A container is provided with a liquid container for containing a liquid and a liquid supply for discharging the liquid of the liquid container. An electronic component is allowed to store data concerning the liquid contained and exchange data with an external device. A takeout step is to take the electronic component out of the liquid cartridge spent. A screening step is to screen out a reusable electronic component out of the electronic components removed. An attaching step is to attach the electronic component screened, in a new container for the liquid cartridge. A write step is to cause the electronic component to store new information.

### BACKGROUND OF THE INVENTION

The present invention relates to a method of recycling a spent liquid cartridge having an electronic component.

It is frequent cases to scrap a liquid (ink) cartridge, mounted and used on an inkjet recorder, as a consumable after the ink is consumed by printing. For this reason, there are proposals that the manufacturer collects spent ink cartridges from users and recycles those, thus preserving the environment. As recycling means, it is known to refill ink in the collected ink cartridges and reproduce those as ink cartridges or to decompose the collected ink cartridges and process those for recycling on a material-by-material basis.

The spent ink cartridges vary in qualities depending upon user's use history besides fixed conditions such as production time, endurance years and number of times reproducible. Consequently, where to recycle a spent ink cartridge due to ink refilling, there is a proposal to use an ink cartridge having storage means storing data concerning ink and data exchange means for exchanging data between the storage means and the external device wherein the storage means has a domain for rewritably storing data concerning ink-cartridge use history (see JP-A-2000-94715). According to such an ink cartridge, storage means stores the use status of an ink cartridge after handed over to the user. During reproducing the same, it is possible to make a reproduction process suited for the relevant ink cartridge depending upon the data in the storage means.

However, when refilling ink in the collected ink cartridge, there is a difficulty in charging a correct amount of ink commensurate with the remaining ink amount, making it difficult to stabilize the quality of the ink cartridge reproduced. Meanwhile, even in case use status is stored in an electronic component such as storage means, there is a need of a manual process for carrying out a reproduction process matched to the individual ink cartridges while grasping various use environments and in consideration of even the possibility of damage during transport. This however is not efficient and greatly cost consuming. In this manner, the ink-filling reproduction process is in a situation not easy to practically adopt as ink-cartridge recycle means.

It is an object of the present invention to provide a method of recycling a liquid cartridge that can suitably recycle a spent liquid cartridge having an electronic component.

Where manually removing an electronic component from a spent ink cartridge by use of a tool such as tweezers or a screwdriver, excessive load such as bending stress is readily caused in the electronic component by forcibly inserting the tool in a back at an end of the electronic component, possibly resulting in poor contact in the terminal due to bending and hence impossible exchange of data. Consequently, yield is lowered in reusing the electronic component taken out. Furthermore, the electronic component in reuse is not easy to assure its reliability.

It is another object to provide a method of taking out an electronic component of a liquid cartridge that can take, with yield, an electronic component in a reusable state out of a liquid cartridge having the electronic component.

In order to transport an electronic component collected from a spent ink cartridge over to a cartridge manufacturing factory, there arises a need to pack the electronic component in a manner not to be damaged.

However, in order to obtain a similar package form for transportation to the new product by separate accommodation as practiced in the IC chip manufacturing factory, there is a need of an exclusive equipment for orienting electronic components and accommodating those in a tray, and of a troublesome manual process (see JP-A-9-172059). Consequently, it is in a situation not efficient and highly cost-consumable to transport the collected electronic components.

It is still another object of the invention to provide a method of packing electronic components and package that electronic components can be packed by simple means and prevented against damage.

### SUMMARY OF THE INVENTION

A method of recycling a liquid cartridge capable of solving the above problem is a method of recycling a liquid cartridge having a container provided with a liquid container for accommodating a liquid and a liquid supply for discharging the liquid of the liquid container, and an electronic component for storing data concerning the accommodated liquid and exchanging information with an external device, the method comprising: a takeout step of taking the electronic component out of the liquid cartridge spent; a screening step of screening a reusable electronic component out of the electronic components taken; an attaching step of attaching the electronic component screened in a new container for the liquid cartridge; and a write step of causing the electronic component to store new information.

The recycling method of a liquid cartridge thus structured is to again attach and use, on a new container, a usable electronic component of among the members structuring the liquid cartridge, thus enabling to recycle at least the electronic component at low cost. Meanwhile, reusable electronic components only are screened out by a screening step. After the electronic component is attached on a new container, a write step is performed to write and store new information required as a new liquid cartridge, thus stabilizing the quality of the liquid cartridge.

Meanwhile, in the method of recycling a liquid cartridge according to the invention, there is preferably comprised of a screening-by-appearance step of judging the electronic component as to a presence or absence of dust adhered thereon, to screen out an electronic component free of dirt adhered. Because the electronic component adhered with liquid dirt cannot be used because of change in the electric characteristic such as resistance value, it is preferred to judge a presence or absence of dirt adhesion from exterior appearance and screen an electronic component free of dirt adhesion.

Meanwhile, the screening-by-appearance step can be performed preceding to the takeout step. It is easy to judge an adhesion of dirt, such as a liquid, in a state remained attached on the container.

Meanwhile, the screening-by-appearance step may be included in the screening step. Namely, the electronic component taken out of the container through the takeout step can be judged as to a presence or absence of dirt adhered.

Meanwhile, in the method of recycling a liquid cartridge according to the invention, the screening step preferably includes to judge the electronic component as to a presence or absence of damage. Because of the possibility of causing a damage, such as cracks, in the electronic component during use or collection of the liquid cartridge or during transportation of the electronic component after removal thereof, the electronic component removed is preferably judged as to a presence or absence of damage in its main and back surfaces entirety, thus screening out an electronic component free of damage.

Meanwhile, in the method of recycling a liquid cartridge according to the invention, the screening step preferably includes to examine the electronic component as to an electronic characteristic thereof. For the collected electronic component, actual function could not be confirmed by a mere judgment as to dirt, damage, etc. from exterior appearance. By examining whether or not having a normal electric characteristic before attachment to a container, it is possible to positively provide a liquid cartridge stable in quality.

Meanwhile, in the method of recycling a liquid cartridge according to the invention, the electronic component preferably stores attachment/detachment count to/from the external device. When the liquid cartridge is attached on an external device such as a liquid ejector, wear occurs at a connection (terminal) of the electronic component, causing deterioration in the electric contact. Accordingly, by storing in the electronic component the attachment/detachment count of the liquid cartridge to/from the external device, the collected electronic component can be judged reusable or not.

Meanwhile, in the method of recycling a liquid cartridge according to the invention, after the takeout step, the container removed of the electronic component is preferably recycle-processed on a material-by-material basis. This makes it possible to make use of wholly the liquid cartridge as a recycling resource, reducing the burden on environment to a possible extent.

Meanwhile, a method of recycling a liquid cartridge capable of solving the above problem is a method of recycling a liquid cartridge having a container provided with a liquid container for accommodating a liquid and a liquid supply for discharging the liquid of the liquid container, and an electronic component for storing data concerning the accommodated liquid and exchanging information with an external device, the method comprising: an attaching step of attaching the electronic component reusable screened out by being taken out of the liquid cartridge spent, to a new container for the liquid cartridge; and a write step of causing the electronic component to store new information.

The recycling method of a liquid cartridge thus structured is to again attach and use, on a new container, a usable electronic component of among the members structuring the liquid cartridge, thus enabling to recycle at least the electronic component at low cost. Meanwhile, because of performing a write step of writing and storing new information required as a new cartridge after screening out only reusable electronic component and the electronic component is attached on a new container, the liquid cartridge is stabilized in quality.

The method of recycling a liquid cartridge according to the invention can suitably recycle the liquid cartridge having an electronic component.

A method of taking out an electronic component of a liquid cartridge, capable of solving the above problem, is a method of taking out an electronic component of a liquid cartridge having a container provided with a liquid container for accommodating a liquid and a liquid supply for discharging the liquid of the liquid container, and an electronic component for storing data concerning the accommodated liquid and exchanging information with an external device, the method comprising: the electronic component being received and fixed in a mount recess of the container in a state exposed at a surface where terminals are provided on a substrate, to push an edge member in a wall structuring an outer edge of the mount recess, in an on-plane direction of the substrate and at an outside of the mount recess, thereby cutting at least a part of the wall, and to insert the edge member in back of the electronic component and remove the electronic component from the mount recess.

In the method of taking out an electronic component out a liquid cartridge thus structured, for the electronic component fit in the mount recess of the container, the wall of the mount recess is cut in an on-plane direction of the substrate whereby the edge member is inserted in back of the electronic component. This can take out the electronic component by reducing the load such as bending to a possible small extent.

Meanwhile, in the method of taking out an electronic component of a liquid cartridge, a positioning projection formed in the mount recess is preferably arranged in a positioning recess formed in the substrate, the electronic component being fixed by crimping the positioning projection in the positioning recess, the edge member, when inserted in back of the electronic component, being to cut the positioning projection.

In the method of taking out an electronic component out a liquid cartridge, the electronic component can be easily taken out of the mount recess by cutting the positioning projection fixing the electronic component by means of the edge member inserted in back of the electronic component.

Meanwhile, in the method of taking out an electronic component of a liquid cartridge, preferably the positioning recess is a through-hole and cutout formed in the substrate, the positioning projection being arranged in the through-hole and cutout, the edge member having an edge and a taper, wherein the edge member, when inserted in back of the electronic component, is to cut the positioning projection and the taper causes the substrate to displace in a manner departing from the positioning recess, and further the positioning projection arranged in the through-hole is disengaged from the through-hole.

In the method of taking out an electronic component of a liquid cartridge thus structured, the positioning projection arranged in the cutout is cut by an edge of the edge member to thereby release the cut out from the fixed state. The positioning projection thus cut falls to the outside of the cutout. Meanwhile, the positioning projection arranged in the through-hole is removed out of the through-hole while being deformed at its crimped portion by lifting the substrate through the taper of the edge member. This can release the fixed state of the positioning recess by suited methods respectively for the through-hole and the cutout. Thus, the electronic component can be taken out without difficulty.

According to the method of taking out an electronic component of a liquid cartridge in the invention, when removing an electronic component from a liquid cartridge having an electronic component, a reusable electronic component can be taken out with yield by reducing the load such as bending to a possible small extent. This can efficiently recycle the electronic component, thus reducing the burden on environment to a possible extent.

A method of packing electronic components, capable of solving the foregoing problem, comprises: accommodating a plurality of electronic components in a flexible plastic film bag; and hermetically closing the electronic components in close contact with the plastic film by evacuating the bag.

According to the method of packing electronic components thus structured, by accommodating a plurality of electronic components in a plastic film bag and evacuating the bag, the flexible plastic film is deformed to a form of the electronic components and closely contacted with the electronic components. This eliminates the bag of such an extra space as to move the electronic components and causes a force acting to hold the electronic components in a direction from the outside to the inside of the bag, thus preventing the electronic components from freely moving in the bag. Meanwhile, a relative movement of the electronic components can be prevented. Due to this, even in a state the plurality of electronic components are contacted one with another within the gag, the plurality of electron components can be prevented from producing dust or being damaged due to mutual friction between those. Accordingly, a package form for transportation can be obtained by extremely simple means without individually accommodating a plurality of electronic components by use of a tray or the like. Meanwhile, because packing is possible in extremely small volume as compared to the case of accommodating a plurality of electronic components in a tray. Thus, a greater number of electronic components can be transported in batch.

Meanwhile, in the method of packing electronic components of the invention, the plastic film is preferably processed with antistatic treatment.

This can protect the accommodated electronic components from static electricity, thus preventing the deterioration in the electronic components.

Meanwhile, in the method of packing electronic components of the invention, evacuation is preferably made to an air pressure within the bag of 900 Pa or lower.

This places the plastic film in close contact, tightly, with the electronic components, thus preventing the electronic components from moving further positively.

Meanwhile, in the method of packing electronic components of the invention, the plastic film is preferably of a material of polyethylene.

By making the plastic film of a material of polyethylene, the bag is less damaged and less broken. Besides, antistatic processing as noted before is readily done. Besides, the condition of gas permeability can be easily fulfilled.

Meanwhile, in the method of packing electronic components of the invention, the electronic component is preferably an IC chip having a plate-like substrate, terminals provided on the substrate and storage means provided in the storage means.

Such IC chips can be accommodated in multiplicity in a bag without an especial need of orientation. Consequently, this can prominently obtain the effect of packing simplification and space saving according to the packing method of the invention.

Meanwhile, a package of electronic components according to the invention capable of solving the problem is characterized by being packed according to the packing method of electronic components of the invention.

The package thus structured can be reduced in volume as compared to the conventional, making it possible to efficiently transport a multiplicity of electronic components.

The method of packing electronic component of the invention can pack electronic components by simple means and prevent the electronic components from being damaged. The package obtained by the method can improve the transportation efficiency of electronic components. Furthermore, electronic components are easily recycled to reduce the burden on environment to a possible low extent.

The present disclosure relates to the subject matter contain in Japanese patent application Nos. 2004-259329 (filed on Sep. 7, 2004), 2004-267881 (filed on Sep. 15, 2004) and 2004-267882 (filed on Sep. 15, 2004), each of which is incorporated herein by reference in its entirety.

### BRIEF DESCRIPTION OF THE DRAWINGS

In the accompanying drawings,

FIG. 1 is a front perspective view, as viewed from obliquely above, showing an example of an ink cartridge for use in a method of taking out an electronic component of a liquid cartridge according to the present invention.

FIG. 2 is a back perspective view of the ink cartridge shown in FIG. 1.

FIG. 3 is a plan view showing the main and back surfaces of the IC chip shown in FIG. 1.

FIG. 4 is a fragmentary perspective view showing, with magnification, a mount region shown in FIG. 1.

FIG. 5 is a fragmentary perspective view showing a state the IC chip is attached in the mount region shown in FIG. 4.

FIG. 6 is a flowchart showing one embodiment of a method of recycling a liquid cartridge according to the invention.

FIG. 7 is a schematic view showing an equipment for carrying out a part of the process shown in FIG. 6.

FIG. 8 is a fragmentary perspective view showing a state an edge member is set up relative to the mount region shown in FIG. 5.

FIG. 9 is a fragmentary perspective view showing a state the edge member shown in FIG. 8 is started pushing against the mount region.

FIG. 10 is a cross-sectional view showing a section on line A-A in FIG. 9.

FIG. 11 is a fragmentary perspective view showing a state the edge member shown in FIG. 9 is started pushing against the mount region.

FIG. 12 is a cross-sectional view showing a section on line B-B in FIG. 11.

FIG. 13 is a plan view showing an example of a bag for use in a method of packing electronic components according to the invention.

FIG. 14 is a plan view showing a state of upon hermetically closing the bag shown in FIG. 13 accommodating the electronic components shown in FIG. 3.

FIG. 15 is a plan view showing a package the bag shown FIG. 14 is hermetically closed.

### DETAILED DESCRIPTION OF THE EMBODIMENTS

The liquid cartridge, applied for the present invention, is suited to supply a liquid to a liquid ejection head of a liquid ejector. The liquid ejector, referred herein, may be a liquid ejection head (recording head) of an inkjet recorder, a coloring-material ejection head of a color-filter former for making a color filter of a liquid-crystal display, an electrode-material (conductive paste) ejection head for forming an electrode for an organic EL display, an FED (flat emission display) or the like, a bioorganic ejection head for a biochip producer for producing a biochip, a sample ejection head as a precise pipette, and so on.

Referring to the drawings, explanation is made on an embodiment of a method of taking out an electronic component of a liquid cartridge according to the invention. Incidentally, the present embodiment explains with an ink cartridge to be removably attached on an inkjet recorder carriage, as an example of a liquid cartridge.

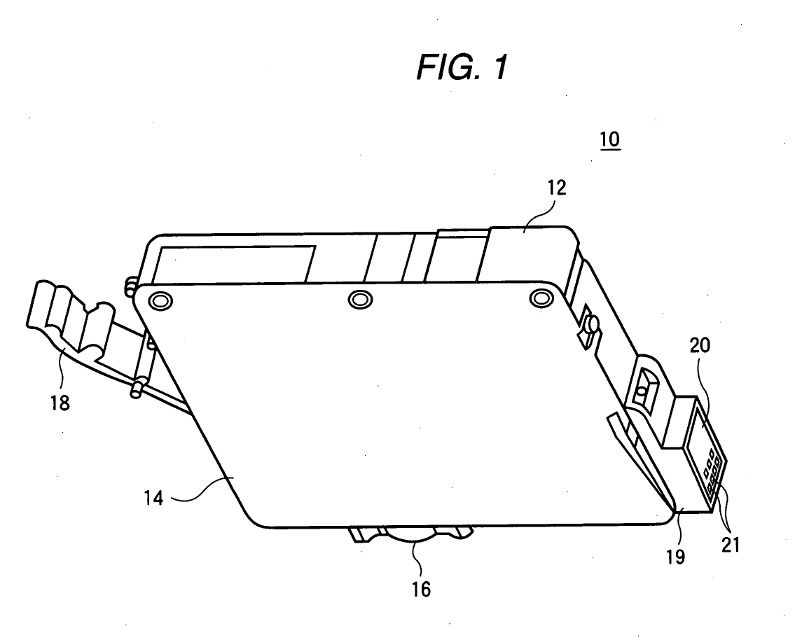

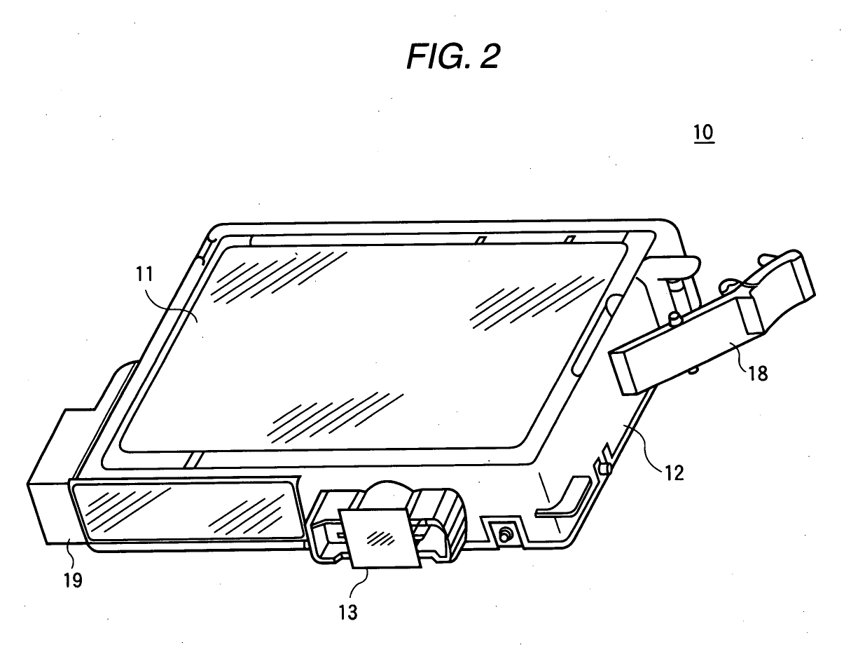

FIG. 1 is a perspective view of an ink cartridge for use in the present embodiment. FIG. 2 is a back perspective view of the ink cartridge 10 of FIG. 1 as viewed from the oblique below. The ink cartridge 10 of this embodiment has a cartridge main body 12 generally in a housing form formed with an ink container (liquid container) to contain an ink in the interior thereof, and a lid 14 covering an opening (not shown) in the cartridge main body 12. These cartridge main body 12 and lid 14 constitute a container as an ink cartridge. Meanwhile, a film (not shown), sealing the opening of the cartridge main body 12, is affixed on the cartridge main body 12.

The cartridge main body 12 and the lid 14 are each formed in one body of a synthetic resin, e.g. polypropylene (PP). The cartridge main body 12 has an interior demarcated into a plurality of recesses 270a, 292a, 294a opened at an opening side to attach the lid 14. The recesses are tightly closed at their openings by means of a film, thus forming a plurality of ink containers to contain ink.

The film, closing the opening of the cartridge main body 12, is a transparent or semitransparent resin film lower in melting point than the cartridge main body 12. By fusing it to the partition wall or rib demarcating with the recesses, ink containers are defined. The film is formed of polyethylene terephthalate (PET), for example.

The lid 14 is fixed on the cartridge main body 12, in a manner covering the film at its outer side in a non-hermetic state.

Meanwhile, the cartridge main body 12 is formed with an ink container for containing ink, a ink passage of from the ink container to an ink supply 16, an ink-side passage communicating the ink container with the air, an air-valve container and an air communicator formed by a air-side passage. The air communicator is made as a region isolated from the air by bonding a film 11 on the partition wall demarcating with the passages.

Furthermore, the ink cartridge 10 has the ink supply 10, ink-supply control means (not shown), an engagement lever 18, an IC (integrated circuit) chip 20 as an electronic component.

The ink supply 16 is arranged in an underside of the cartridge main body 12. This is inserted by an ink supply needle formed on the carriage to which the ink cartridge 10 is to be mounted, to supply the ink contained in the ink container to a recording head of the carriage. The ink supply 16 has a seal member formed of elastomer or the like having an insertion port to be inserted by the ink supply needle provided on the carriage, a supply valve closing the insertion port of the seal member, and a biasing member made by a coil spring or the like to bias the supply valve toward the seal member. Note that, upon shipment at the factory, the film 13 is affixed on the insertion port of the seal member.

The ink-supply control means structures a pressure-difference valve for supplying the ink in the ink container to the ink supply 16 due to the pressure difference between the ink container and the ink supply 16 caused by ink consumption. Meanwhile, the ink-supply control means has a coil spring biasing to close the pressure-difference valve.

The engagement lever 18, formed on an opposite side surface of cartridge main body 12 to an attacher 19, is for engagement with the carriage of the inkjet recorder. The attacher 19 has a side surface to be regulated by the rib formed on the carriage so that positive abutment can be provided between the terminal 21 of the IC chip 20 and the elastic contact on the carriage.

The IC chip 20 is fixed within the attacher 19. The attacher 19 is provided by crimping in the lower side surface of the cartridge main body 12. Incidentally, the attacher 19 may be formed integral with the cartridge main body 12.

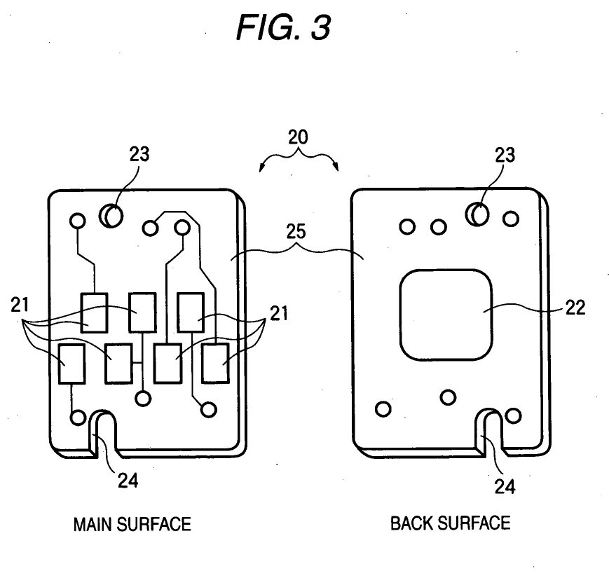

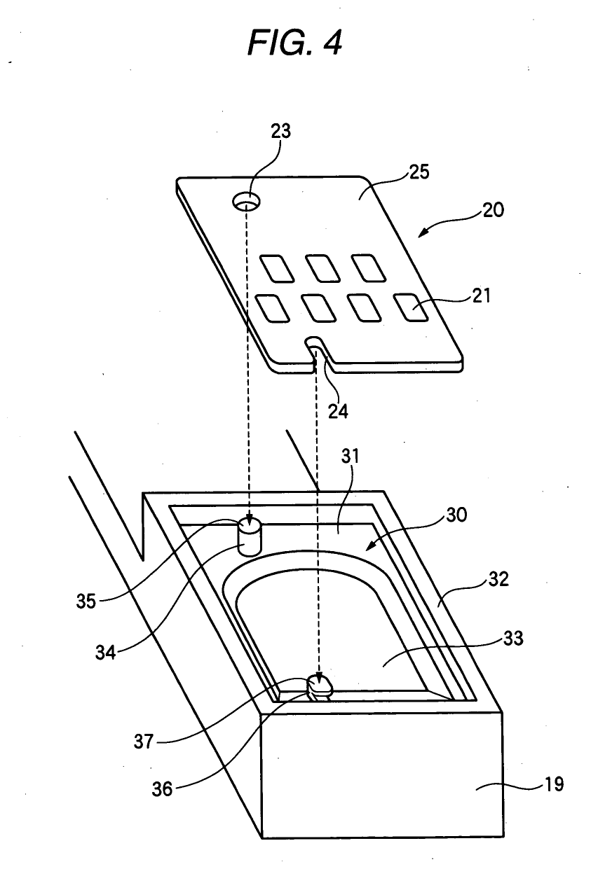

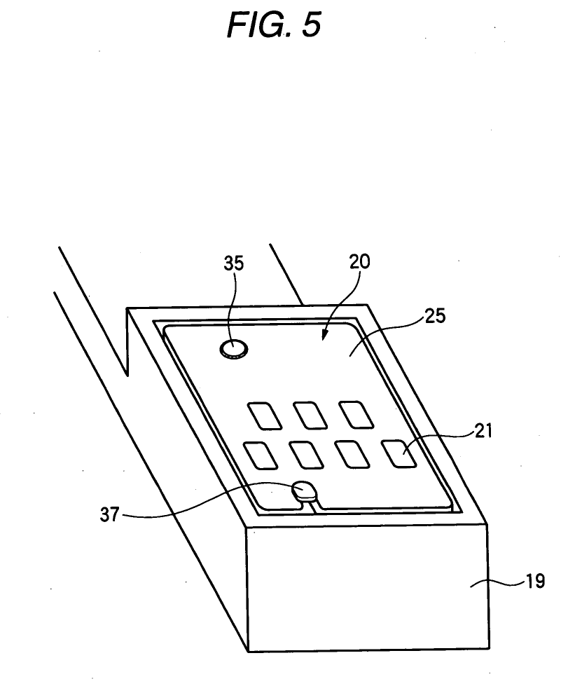

The IC chip 20 is provided with a plurality of terminals 21 on a surface of a substrate 25 in a plate form, as shown in FIG. 3. It has, on a backside, storage means 22 accessible from the terminals 21. The substrate 25, formed of glass and epoxy resin, is formed with a through-hole 23 and cutout 24 as a positioning recess for fixing by crimping to the attacher 19 of the cartridge main body 12.

Meanwhile, the IC chip 20 is received and fixed in the mount recess 30 formed in the attacher 19, in a state exposed at its surface. The mount recess 30 is provided with a bottom 31 formed slightly greater than the substrate 25 in order to accommodate the substrate 25 of the IC chip 20, thus having an outer edge formed by a wall 32. In the bottom, a pin 34 and rib 36 is provided standing as a positioning projection in a position corresponding to the through-hole 23 and cutout 24 formed in the substrate 25. By positioning those respectively in the through-hole 23 and the cutout 24, the IC chip 20 is positioned in position. Meanwhile, in the central region of the bottom 31, a space 33 is provided to receive the storage means 22 (see FIG. 3) provided protruding on the back of the substrate 25. Incidentally, the wall 32, the pin 34 and the rib 36 have a height, relative to the bottom 31, slightly greater than the thickness of the substrate 25 of the IC chip 20.

The IC chip 20, thus received in the mount recess 30, is fixed in the mount recess 30 through thermal crimp by thermally softening the summits 35, 37 of the pin 34 and rib 36 projecting toward the surface of the substrate 25 and pushed in the through-hole 23 and cutout 24 of the substrate 25. Incidentally, the pin 3 and the rib 36 can be used merely for positioning without thermal fitting, to fix the back of the substrate 25 and the bottom 31 together by an adhesive.

Meanwhile, the IC chip 20, at its storage means 22, stores information about the ink cartridge 10 and ink, to exchange those pieces of information with the inkjet recorder main body through the plurality of terminals 21 exposed in the surface thereof. The information, stored in the storage means 22, includes ink cartridge 10 kind, color of the ink held in the ink cartridge 10, ink remaining amount, attachment/detachment count to/from the carriage, use time, ink end time, use status and so on, besides fixed information such as ink cartridge 10 production date and durable years. Meanwhile, the character strings, having an unambiguous relationship with those pieces of information, can be stored rewritable at any time in a predetermined domain. Incidentally, where various pieces of information are stored by means of character strings, decode data may be stored on a recorder side. This can greatly reduce the storage capacity of the storage means 22.

Besides, within the ink cartridge 10, there is provided a filter, etc. having a function of ink repellence and permeability.

For the ink cartridge 10 thus structured, printing is carried out by means of the inkjet recorder and the ink is consumed gradually. The information about the remaining amount of the ink is stored in the IC chip at proper time. When the information about the ink remaining amount stored in the IC chip 20 becomes zero and the inkjet recorder reads the information thereof, a message of ink exhaustion, etc. is displayed on the computer driving the inkjet recorder and notified to the user. Due to this, the user is allowed to detach the ink cartridge 10 exhausted of ink from the carriage of the inkjet recorder.

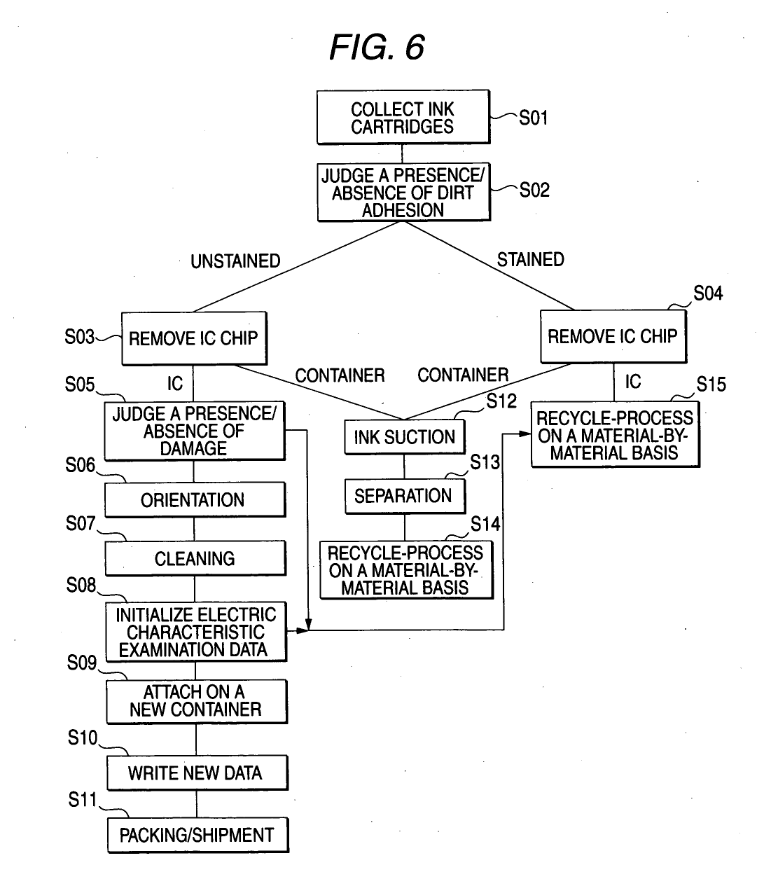

Referring to FIG. 6, explanation is made on a method of recycling an ink cartridge 10 thus used up.

At first, the spent ink cartridges 10 are collected by the collection post set up at the store in each region or through collection activity (step S01: collection step).

The collected ink cartridges 10 are transported to a recycle factory where the operator first checks from external appearance whether there is a dirt with ink or the like on the surface of the IC chip 20 (step S02: screening-by-appearance step). In the appearance check, it is satisfactory to make a visual confirmation directly or a confirmation by use of magnifying visual means such as a microscope. Incidentally, the screening-by-appearance step may be mechanically made by means such as image processing in place of by the operator. It is easy to visually check only the surface of the IC chip 20 in a state the IC chip 20 is attached on the ink cartridge 10.

By the screening-by-appearance step, screening is made into those of ink cartridges 10 not adhered with dirt on the IC chip 20 and those of ink cartridges 10 adhered with dirt on the IC chip 20.

The ink cartridge 10 passed the screening-by-appearance step is removed of its IC chip 20 regardless of whether or not there is dirt thereon (step S03, S04: removal step). However, removal is preferably on separate lines depending upon a presence or absence of dirt. Such removal may be by operator's manual operation using a tool or mechanically by use of an exclusive removal machine. Here, the removed IC chip 20 may be transported to a separate recycle factory or an ink cartridge production factory where it is subjected to the subsequent step for recycle. In this case, the IC chip 20 removed as a part of the ink cartridge 10 is suppressed low in its transportation cost.

For the unstained IC chips 20 passed the removal step S03, screening is made on the both surface of the IC chip 20 by operator's appearance check whether or not there is a damage such as cracks (step S05: screening-by-damage step). Then, undamaged IC chips 20 are oriented and cleaned, and then subjected to electric characteristic test.

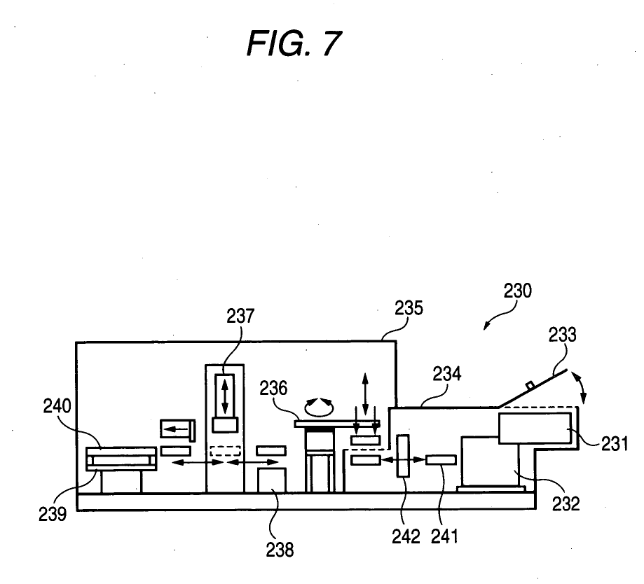

There is shown in FIG. 7 an example of an equipment for carrying out orientation, cleaning and electric characteristic test of the IC chip 20.

The equipment 230 shown in FIG. 7 is provided with outer shells 234, 235 shielding the interior of the equipment 230 from the external air. The IC chip 20 is put in an entrance box 231 by opening an opening-and-closing lid 233 of the outer shell 234 provided on the light in the figure. The entrance box 231 is arranged above a parts feeder board 232 set up inside the outer shell 234. The IC chips 20 thus put are gradually fed to the parts feeder board 232. The parts feeder board 232 orients the fed ICs one by one into a predetermined position (step S06: orientation step) and supplies those toward the downstream (leftward in the figure).

The IC chips 20 fed from the parts feeder board 232 is held in a predetermined position in a tray 241 in which state those are passed the cleaning section 242 (step S07: cleaning step) and conveyed further downward. In the cleaning section 242, air is blown to the IC chip 20 to thereby blow off the foreign matter, dust, etc. adhered on the IC chip 20. Furthermore, air suction is also made to keep the interior of the outer shell 234 clean.

The IC chip 20 passed the cleaning section 242 is transported from the interior of the outer shell 234 into the outer shell 235 by a rotary stage 236 set up within the outer shell 235. Then, the IC chip 20 is conducted an electric characteristic examination by a examining section 237 set up inside the outer shell 234 (step S08: electric characteristic examination step). Meanwhile, for the IC chip 20 judged good in electric characteristic, the information stored in the examining section 237 is initialized and information capable of judging as a reused component is written.

The IC chip 20, judged good in electric characteristic, is further sent to the downstream. Meanwhile, the IC chip 20, judged poor in electric characteristic, is returned to the upstream and placed in an unacceptable-component collection box 238.

Incidentally, because the terminals 21 on the IC chip 20 are worn out and deteriorated by attachment/detachment of the ink cartridge to/from the carriage, it is preferred to decide whether or not a predetermined allowable count of attachment/detachment is reached by reading the information about attachment/detachment count stored in the IC chip 20, simultaneously with conducting an electric characteristic examination. In the case the allowable attachment/detachment count is reached, decision is made as nonreusable and the IC chip 20 is placed in the unacceptable-component collection box 238.

The IC chip 20, judged good in electric characteristic, is fed to the downstream and held in a tray 240. The tray 240 is allowed to move on-plane by a position adjusting mechanism 239 such as an XY table, and hold a multiplicity of IC chips 20 in a matrix arrangement. The multiplicity of IC chips 20, held in the tray 240, are transported in batch of the tray 240 to the next operation step.

By thus performing cleaning and information initialization together with screening of only the reusable electronic components by the screening step (steps S05, S08) as to the removed IC chips 20, it is possible to obtain an IC chip 20 that can be attached in a new container of an ink cartridge. Such an IC chip 20 is attached in a new container (step S09: attaching step) and new information required depending upon the kind of the ink cartridge is written to the IC chip (step S10: write step). Such ink cartridges are properly packed and shipped out (step S11: shipment step).

Incidentally, the screening-by-appearance step (step S02) may be made in a state the IC chip 20 is removed. In such a case, the screening-by-appearance step for deciding the presence/absence of dirt adhesion can be performed together with the damage presence/absence deciding step (step S08) after the IC chip 20 removal step (step S03). Namely, the step of screening reusable IC chips 20 is concentrated after the removal step (step S03) thus improving the efficiency of screening operation.

Meanwhile, as shown in FIG. 6 to be referred again, because the container of an ink cartridge 10 removed of its IC chip 20 is presumably deteriorated in a part contacted with ink or affected by property/characteristic change, etc. in the remaining ink, suitable recycle step is performed on a material-by-material basis. In a recycle step, after the remaining ink is first sucked (step S12; ink suction step), the container entirety is broken. After washing with water flow, the resin material (PP) structuring the most part of the container and the films, seal members, filters, etc. included in the container are separated on a material-by-material basis by use of the difference in specific gravity (step S13: separation step). Then, recycle step is carried out on a material-by-material basis (step S14: recycle step), and made into a commercial product, e.g. plastic product such as a transport container or a combustion improver.

The IC chips 20, judged nonreusable through the screening-by-appearance step (step S02) and screening step (steps S05, S08), are also crushed and then separated on a material-by-material basis by use of the difference in specific gravity. Thus, material-based recycle step is carried out (step S15: recycle step).

As explained so far, according to the method of reusing a liquid cartridge in this embodiment, because the IC chip reusable of the members structuring the ink cartridge is again attached and used on a new container, at least the IC chip can be recycled at low cost. Meanwhile, because the IC chip rendered reusable by the screening step is written with new information required as a new liquid cartridge and used as a product, it is possible to stabilize the quality of the ink cartridge commercially produced by reutilization of the IC chip. Meanwhile, because the ink cartridge entirety can be made use of as a recycle resource, the burden on environment can be greatly reduced.

Now, explanation is made on a method of taking out an IC chip 20 of a spent ink cartridge.

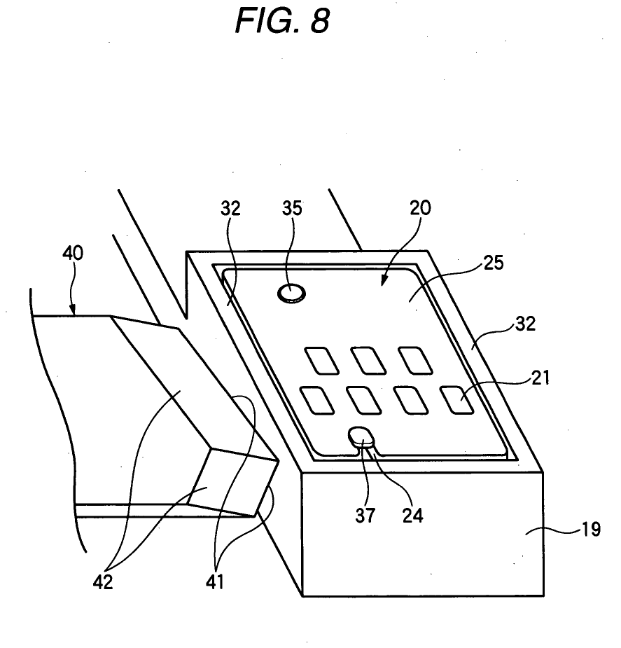

At first, the ink cartridge 10 is fixed in a predetermined position on a table, by clamping or so. Meanwhile, prepared is an edge member 40 as shown in FIG. 8. The edge member 40, shown herein, is formed of a tough metal, such as steel, thus having an edge 41 at a tip and a taper 42 as a slant surface. The edge member 40, in a state its taper 25 is directed toward the surface of the substrate 25, is set facing the IC chip 20, in a position outside the longer-side wall 32 of the substrate 25 and directed toward the IC chip 20. The edge 41 is placed on a plane parallel with the surface of the substrate 25 and passing the backside of the substrate 25. By sliding the edge member 40 along a shorter-side direction of the substrate 25 on the plane the edge 41 is arranged, the edge 41 is pushed in the longer-side wall 32 of the substrate 25.

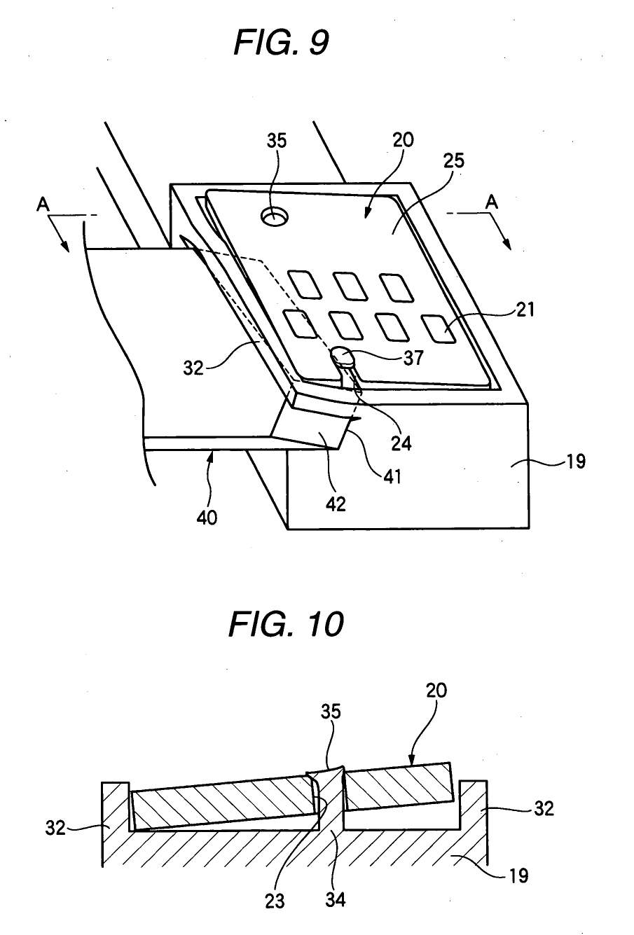

As shown in FIG. 9, as the edge 41 gradually cuts the wall 32 to insert the edge member 40 in back of the IC chip 20, the rib 36 is cut out in the beneath of the summit 37 crimped the cutout 24. At this time, the edge member 40 is inserted in back of the IC chip 20 whereby the IC chip 20 gets on the taper 42. The IC chip 20 is lifted somewhat by the slant of the taper 42. FIG. 10 shows a cross-sectional view in this state taken on line A-A in FIG. 9. As shown in FIG. 10, when the IC chip is lifted, the summit 35 crimped of the pin 34 is lifted up and deformed by a force applied from the through-hole 23.

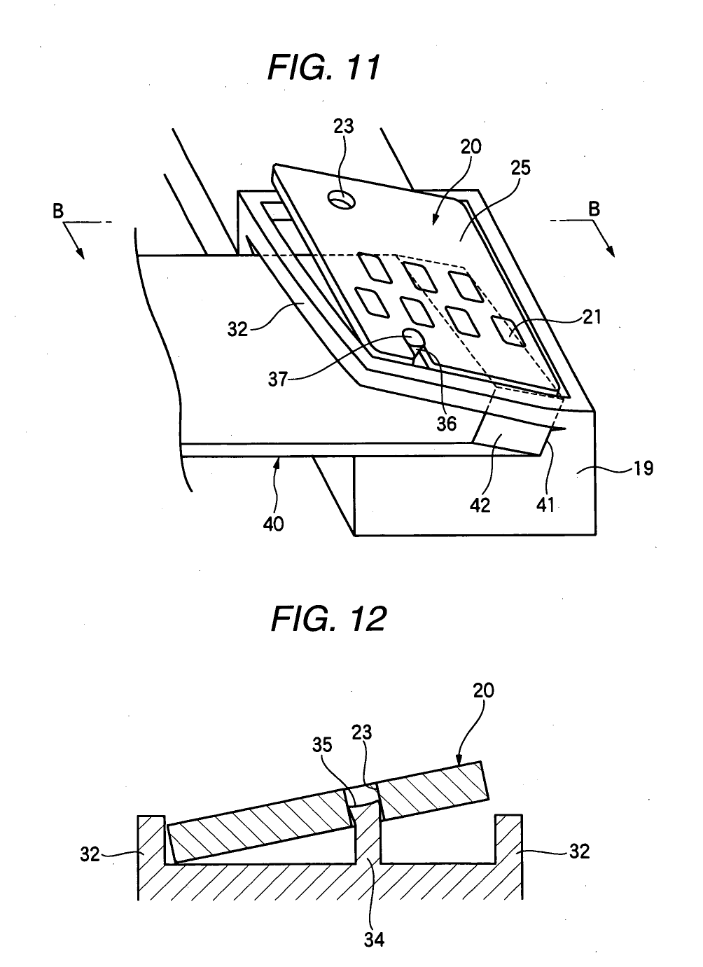

Furthermore, the edge member 40 is further pushed deep in back of the IC chip 20, the IC chip 20 is further lifted up by the taper 42 as shown in FIG. 11. FIG. 12 shows a cross-sectional view in this state, taken on line B-B in FIG. 11. As shown in FIG. 12, the summit 35 of the pin 34 is deformed thinner by the IC chip 20 lifted up greatly, thus being sunk in the through-hole 23. In case the edge member 40 is further pushed, the IC chip 20 completely gets on the edge member 40. Ultimately, the pin 34 is withdrawn from the through-hole 23 and hence the IC chip 20 is removed from the pin 34.

Meanwhile, the rib 36 thus cut is to move in the on-plane direction of the substrate 25 from the cutout 24 through the action of self-weight or the like, thus falling out naturally.

In this manner, the IC chip 20 can be easily taken out of the mount recess 30 without causing a forcible bending stress or the like to the substrate 25, etc. Namely, the IC chip 20 can be taken out in a reusable state without causing any deformation or damage to the IC chip 20.

As explained so far, according to the method of taking out an electronic component of a liquid cartridge in this embodiment, an electronic component (IC chip 20) can be taken out with yield in a reusable state, of among the component constituting the liquid (ink) cartridge. Thus, electronic component recycle is made possible efficiently.

Incidentally, the edge member 40 shown in the embodiment is not limited in form to the embodiment shown but can be modified properly. For example, the edge 41 and the taper 42 can be positioned parallel with the traveling direction of the edge member 40. Meanwhile, both the rib 36 and the pin 34 may be cut by the edge member 40. In such a case, the pin 34 after cutting may be withdrawn out of the through-hole 23.

IC chips 20 can be removed continuously on a plurality of ink cartridges 10 by the edge member 40 in the embodiment by building an exclusive takeout device. For example, the ink cartridges 10 set a plurality in the number are sent one by one to a predetermined position where positioning and fixing is made to cut the attacher 19 by means of a slidable edge member 40, followed by a sequential removal operation In this case, removal is possible in a time of approximately 3 seconds on one ink cartridge, for example.

Meanwhile, the container of the ink cartridge 10 removed of its IC chip 20 is presumably deteriorated in a part contacted with ink or affected by property/characteristic change, etc. in the remaining ink. Accordingly, suitable recycle step is preferably performed on a material-by-material basis. In a recycle step, after the remaining ink is first sucked, the container entirety is broken. After washing with water flow, the resin material (PP) structuring the most part of the container and the films, seal members, filters, etc. included in the container are separated on a material-by-material basis by use of the difference in specific gravity. Then, recycle step is carried out on a material-by-material basis, and made into a commercial product, e.g. plastic product such as a transport container or a combustion improver. This can make use of the ink cartridge 10 entirety as a recycled resource, thus greatly reducing the burden on environment.

Referring to the drawings, explanation is made on an embodiment of a method packing electronic components and package according to the invention. Incidentally, this embodiment explains a case employing, as electronic component example, an IC chip to be mounted on an ink cartridge.

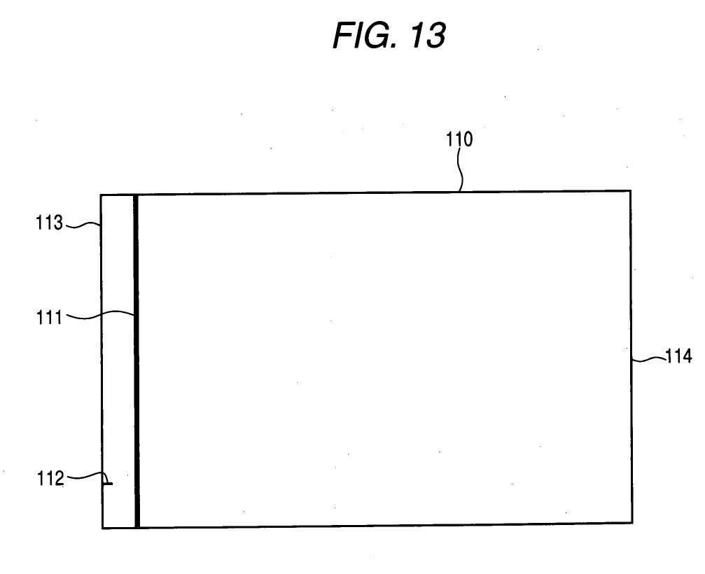

FIG. 13 is a plan view of a bag for use in packing IC chips in this embodiment. The bag 110 shown in FIG. 13 is a bag formed by a flexible plastic film. This is, for example, a plastic film formed cylindrical, for example, cut by forming a thermal seal 111 at a lengthwise interval. The thermal seal 111 is positioned closer to one end 113 of the bag 110, thus hermetically closing the end 113. Meanwhile, an opening notch 112 is formed in the end 113. Incidentally, the other end 114 is opened before putting IC chips in the bag 110.

The plastic film structuring the bag 110 is a film made of a material, for example, of low-density polyethylene (LDPE), having a thickness of 0.1 mm. Meanwhile, the plastic film is preferably low in gas permeability to a possible extent in consideration of evacuating the bag 110 of air and hermetically closing it.

Meanwhile, the plastic film can suitably use a material of high-density polyethylene (HDPE) or polypropylene (PP) besides low-density polyethylene noted above. Those materials are easily reduced in gas permeability by suitably selecting the thickness. Meanwhile, those are suited as package film because-of not easily damaged and torn.

Meanwhile, the materials such as polyethylene and polypropylene, generally, are excellent in electric insulation and hence readily electrified wherein the static electricity charged is not easy to leak. Accordingly, dust adhesion readily occurs besides the fear of deterioration in the electronic components, such as IC chips, put in. Meanwhile, where the plastic film is electrified with static electricity, operation efficiency is possibly lowered by attraction or repelling at between those films. In order not to cause such an inconvenience due to static electricity, electric conductivity is preferably provided to polyethylene or polypropylene. For providing electric conductivity to polyethylene or polypropylene, it is satisfactory to add an antistatic agent, e.g. surfactant, to the material of polyethylene or polypropylene. Otherwise, it may be applied to a surface of a formed film to form an antistatic film, thus providing an antistatic treatment. Due to this, electrification with static electricity is not ready to occur thus preventing against IC chip deterioration. Besides, because dust adhesion is also prevented, those can be brought in a clean room.

The IC chips 20 are gathered and remove of foreign matters, such as chips and dusts, by means of a screen, and then placed a predetermined number a time in the bag 110. In accommodation, a multiplicity of IC chips 20 can be accommodated in a state contacted one with another without the need to orient the IC chips 20. Meanwhile, the number of IC chips 20 to be put in one bag 110 may be regulated by managing the weight thereof.

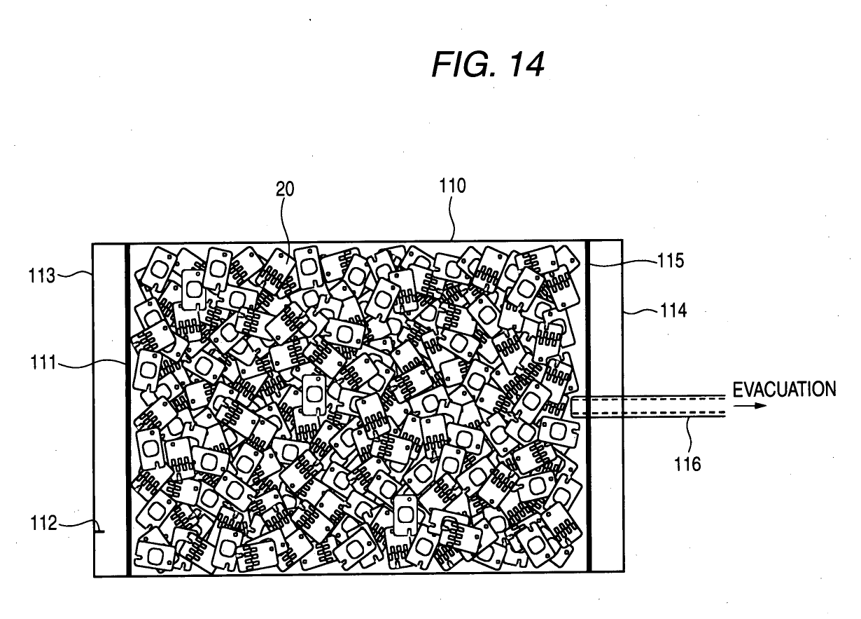

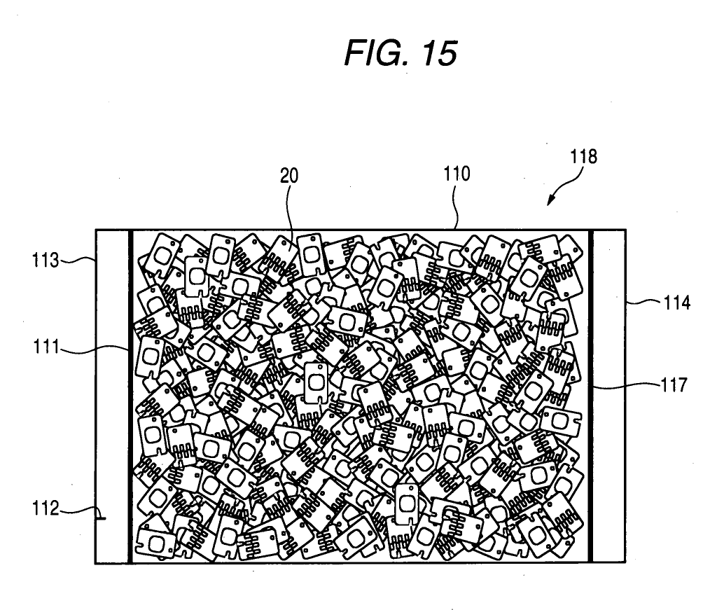

Then, as shown in FIG. 14, by inserting a suction nozzle 116 in a flat cylinder form in the other end 14, the bag 110 is evacuated by the suction nozzle 116 while clamping, at both sides, a to-be-sealed portion of the bag 110 in a position near the end 14 by means of a thermal-sealing heater member (not shown). Due to this, the plastic film of the bag 110 is placed in close contact with the IC chips. Immediately after completing the evacuation, the suction nozzle 116 is withdrawn from the bag 110. The to-be-sealed portion 115 is thermally sealed by the heater member, to form a thermal seal 117 (see FIG. 15) and hermetically closing the bag 110. This can obtain a package 118 (see FIG. 15) of IC chips 20 in a package form for transport, by an extremely simple means.

The obtained package 118 is affixed with a label describing lot, number, weight, etc. and arranged together with cushion members, such as foam sheet or damper, in an exterior box, such as a corrugated box. Then, a label describing lot, number, weight, etc. is affixed to the exterior box, and arranged on an exterior-box tray and packed, followed by shipment.

As for the package 118, the bag 110 is deformed to the shape of IC chips 20 and closely contacted with the IC chips 20. Within the gab 110, there is removed of such a space that allows the IC chips 20 to move. Because of a force acting to holding the IC chips from the exterior to interior of the bag 110 due to a pressure difference, there is no possibility that the IC chips 20 freely move during transportation, thus not to cause a relative movement of the IC chips 20. Incidentally, in order to prevent more positively the IC chips 20 from moving, it is preferred to evacuate the bag 110 down to an air pressure of 900 Pa or lower.

Meanwhile, the package 118 can prevent against dust occurrence or breakage due to mutual friction of the IC chips 20 even in a state the plurality of IC chips 20 are contacted one with another within the bag 110. As compared to the case to accommodating a plurality of IC chips 20 on a tray as in the conventional, packaging is possible in extremely small volume, thus enabling to transport a greater number of IC chips 20 in batch.

Meanwhile, by setting low the gas permeability of the plastic film structuring the bag 110, the sealed bag 110 is facilitated to keep the evacuated state. Even after the time passage, for example, of several months due to transport or storage of the package 118, the close contact state of the IC chips 20 with the plastic film can be maintained in a degree free from movement.

Meanwhile, in case the bag 110 is finished antistatic, the IC cartridges 20 can be brought, as they are, in a clean room for mounting those on new ink cartridges.

Incidentally, although the embodiment exemplified the ink-cartridge IC chips as electronic components to be packed, the electronic components to be packed according to the method of packing electronic components may be printer-circuit boards, LSIs or the like.

1. A method of recycling a liquid cartridge having a container provided with a liquid container for accommodating a liquid and a liquid supply for discharging the liquid of the liquid container, and an electronic component for storing data concerning the accommodated liquid and exchanging information with an external device, the method comprising:
a takeout step of taking the electronic component out of the liquid cartridge spent;
a screening step of screening a reusable electronic component out of the electronic components taken;
an attaching step of attaching the electronic component screened, in a new container for the liquid cartridge; and
a write step of causing the electronic component to store new information.

2. A method of recycling a liquid cartridge according to claim 1, comprising a screening-by-appearance step of judging the electronic component as to a presence or absence of dust adhered thereon, to screen out an electronic component free of dust adhesion.

3. A method of recycling a liquid cartridge according to claim 2, wherein the screening-by-appearance step is performed preceding to the takeout step.

4. A method of recycling a liquid cartridge according to claim 2, wherein the screening-by-appearance step is included in the screening step.

5. A method of recycling a liquid cartridge according to claim 1, wherein the screening step includes to judge the electronic component as to a presence or absence of damage.

6. A method of recycling a liquid cartridge according to claim 1, wherein the screening step includes to examine the electronic component as to an electronic characteristic thereof.

7. A method of recycling a liquid cartridge according to claim 1, wherein the electronic component stores attachment/detachment count to/from the external device.

8. A method of recycling a liquid cartridge according to claim 1, wherein, after the takeout step, the container removed of the electronic component is recycle-processed on a material-by-material basis.

9. A method of recycling a liquid cartridge according to claim 1, wherein the electronic component is received and fixed in a mount recess of the container, in a state exposed at a surface where terminals are provided on a substrate,
to push an edge member in a wall structuring an outer edge of the mount recess, in an on-plane direction of the substrate and at an outside of the mount recess, thereby cutting at least a part of the wall, and
to insert the edge member in back of the electronic component and remove the electronic component from the mount recess.

10. A method of recycling a liquid cartridge according to claim 1, further including a packing step of accommodating a plurality of electronic components in a flexible plastic film bag and evacuating the bag to thereby pack the electronic component in a state closely contacted with the plastic film.

11. A method of recycling a liquid cartridge according to claim 9, further including a packing step of accommodating a plurality of electronic components in a flexible plastic film bag and evacuating the bag to thereby pack the electronic component in a state closely contacted with the plastic film.

12. A method of recycling a liquid cartridge having a container provided with a liquid container for accommodating a liquid and a liquid supply for discharging the liquid of the liquid container, and an electronic component for storing data concerning the accommodated liquid and exchanging information with an external device, the method comprising:
an attaching step of attaching the electronic component reusable screened out by being taken out of the liquid cartridge spent, to a new container for the liquid cartridge; and
a write step of causing the electronic component to store new information.

13. A method of taking out an electronic component of a liquid cartridge having a container provided with a liquid container for accommodating a liquid and a liquid supply for discharging the liquid of the liquid container, and an electronic component for storing data concerning the accommodated liquid and exchanging information with an external device, the method comprising:
the electronic component being received and fixed in a mount recess of the container in a state exposed at a surface where terminals are provided on a substrate,
to push an edge member in a wall structuring an outer edge of the mount recess, in an on-plane direction of the substrate and at an outside of the mount recess, thereby cutting at least a part of the wall, and
to insert the edge member in back of the electronic component and remove the electronic component from the mount recess.

14. A method of taking out an electronic component of a liquid cartridge according to claim 13, wherein a positioning projection formed in the mount recess is arranged in a positioning recess formed in the substrate, the electronic component being fixed by crimping the positioning projection in the positioning recess,
the edge member, when inserted in back of the electronic component, being to cut the positioning projection.

15. A method of taking out an electronic component of a liquid cartridge according to claim 14, wherein the positioning recess is a through-hole and cutout formed in the substrate,
the positioning projection being arranged in the through-hole and cutout,
the edge member having an edge and a taper,
wherein the edge member, when inserted in back of the electronic component, is to cut the positioning projection and the taper causes the substrate to displace in a manner departing from the positioning recess, and further the positioning projection arranged in the through-hole is disengaged from the through-hole.

16. A method of packing electronic components comprising:
accommodating a plurality of electronic components in a flexible plastic film bag; and
hermetically closing the electronic components in close contact with the plastic film by evacuating the bag.

17. A method of packing electronic components according to claim 16, wherein the plastic film is processed with antistatic treatment.

18. A method of packing electronic components according to claim 16, wherein evacuation is made to an air pressure within the bag of 900 Pa or lower.

19. A method of packing electronic components according to claim 16, wherein the plastic film is of a material of polyethylene.

20. A method of packing electronic components according to claim 16, wherein the electronic component is an IC chip having a plate-like substrate, terminals provided on the substrate and storage means provided in the storage means.

21. A package of electronic components packed according to the method of packing electronic components according to claim 16.
